(19) United States
(12) Patent Application Publication
(10) Pub. No.: US 2022/0099150 A1
(43) Pub. Date: Mar. 31, 2022

(54) BRAKE DISC ASSEMBLY AND METHOD

(71) Applicant: Westinghouse Air Brake Technologies Corporation, Wilmerding, PA (US)

(72) Inventors: Roberto Boffelli, Camisano (IT); Claudino Goncalves, Ribeaucourt (FR); Roberto Tione, Lauriano (IT)

(21) Appl. No.: 17/432,603

(22) PCT Filed: Feb. 18, 2020
(86) PCT No.: PCT/US2020/018650

§ 371 Date: Aug. 20, 2021

Related U.S. Application Data
(60) Provisional application No. 62/808,421, filed on Feb. 21, 2019.

(51) Int. Cl. F16D 65/12

(52) U.S. Cl. CPC F16D 65/128; F16D 2065/1328; F16D 65/121

(57) ABSTRACT

A brake disc configured to control airflow through portions of a brake disc assembly includes a brake disc, at least one airflow restrictor, and an actuator. The at least one airflow restrictor includes at least one gate member configured to move between a closed position and an open position. In the closed position, the at least one gate member at least partially reduces airflow between a circumferential inner edge and a circumferential outer edge of the brake disc. In the open position, the at least one gate member is positioned to permit increased airflow between the circumferential inner edge and the circumferential outer edge of the brake disc, relative to when the at least one gate member is in the closed position. The actuator is coupled to the at least one airflow restrictor and configured to move the restrictor between the open position and the closed position.

### CROSS-REFERENCE TO RELATED APPLICATIONS

This application is a national stage entry of International PCT Application No. PCT/US2020/018650, filed on 18 Feb. 2020, which claims priority to U.S. Provisional Patent App. Ser. No. 62/808,421 filed on 21 Feb. 2019, the contents of which are incorporated herein in their entirety.

### BACKGROUND

### Technical Field

The disclosure includes embodiments that relate to a brake disc assembly for a rotating body. Embodiments relate to brake disc assemblies including airflow restrictors.

### Description of Art

Brake discs may be affixed to wheels or rotors to provide a smooth, hard contact surface that can be contacted by a brake shoe or pad controlled by a brake mechanism, such as a brake jaw. When contact between the disc and brake shoe or pad is established, friction between the elements is sufficient to slow or stop rotation of the wheel. Brake discs are used in a variety of applications including, for example, industrial machines, such as cranes and lifts, as well as in conveying installations, such as escalators, elevators, ski-lifts, and the like. Brake disc assemblies may be employed in transport vehicles, such as rail cars, public transportation vehicles, trucks, and automobiles.

Heat may be created as a result of the frictional contact between the brake shoe and brake disc. The heat may cause thermal expansion of portions of the brake disc assembly and may cause the brake disc assembly to deform or degrade following prolonged use. A conventional braking apparatus may not permit uniform distribution of the generated heat leading to wide temperature gradients across the braking assembly. Such temperature gradients may cause fissures and cracks to form in the brake disc. Additionally, cooling airflow may not be sufficiently uniform nor adequate to counteract the destructive effects of the heat being generated. Instead, cooling air may actually increase temperature gradients on the brake disc worsening thermal transitional phenomena. Heat that is created on the contact surface of the brake element may be transferred to the shaft on which the brake disc is mounted. This transferred heat may cause oxidation to occur on the shaft and/or wheel making replacing brake elements more difficult. Prolonged heat exposure may alter the centering or calibration of the brake elements and/or drive members.

Other annular brake discs may include radial fins or gills for directing airflow between front and rear brake discs of a brake disc assembly. The front and rear brake discs include openings on the disc surface located near the central portion of the wheel or wheel hub. Air is drawn into the openings and directed radially outward along the inner surface of the brake discs by the fins or gills. Heat created by the brake disc is transferred to the fins or gills and ventilated by the airflow. In this way, the fins or gills may remove heat from the brake disc and wheel. It may be desirable to have a brake system and method that differs from those that are currently available.

### SUMMARY

In one embodiment, a brake disc assembly for a vehicle is provided. The brake disc assembly is configured to control airflow through portions of the brake disc assembly, and includes a brake disc, at least one airflow restrictor, and an actuator. The at least one airflow restrictor includes at least one gate member configured to move between a closed position and an open position. In the closed position, the at least one gate member at least partially reduces airflow between a circumferential inner edge and a circumferential outer edge of the brake disc. In the open position, the at least one gate member is positioned to permit increased airflow between the circumferential inner edge and the circumferential outer edge of the brake disc, relative to when the at least one gate member is in the closed position. The actuator is coupled to the at least one airflow restrictor and configured to move the restrictor between the open position and the closed position.

In one embodiment, a brake disc hub of a vehicle includes an annular body, at least one airflow restrictor, and an actuator. The annular body includes a radially inner portion configured to receive an axle of a vehicle and a radially extending flange configured to be connected to a brake disc. The at least one airflow restrictor includes at least one gate member mounted to the flange of the hub configured to move between a closed position and an open position. In the closed position, the at least one gate member at least partially reduces airflow between a circumferential inner edge and a circumferential outer edge of the brake disc. In the open position, the at least one gate member is positioned to permit increased airflow between the circumferential inner edge and the circumferential outer edge of the brake disc, relative to when the at least one gate member is in the closed position. The actuator is coupled to the at least one airflow restrictor and configured to move the restrictor between the open position and the closed position.

In one embodiment, a method includes positioning at least one gate member of an airflow restrictor in a closed position, wherein the at least one gate member at least partially reduces airflow between a circumferential inner edge and a circumferential outer edge of a brake disc in the closed position. The method also includes moving, via an actuator, the at least one gate member to an open position, in which the at least one gate member is positioned to permit increased airflow between the circumferential inner edge and the circumferential outer edge of the brake disc, relative to when the at least one gate member is in the closed position.

### BRIEF DESCRIPTION OF THE DRAWINGS

FIG. 1 is a front view of a brake disc assembly according to an aspect of the disclosure;

FIG. 2 is a cross-sectional view of a portion of the assembly of FIG. 1 along line A-A in FIG. 1;

FIG. 3 is a cross-sectional view of a portion of the assembly of FIG. 1 along line B-B in FIG. 1;

FIG. 4 is a cross-sectional view of a portion of the assembly of FIG. 1 taken along a plane parallel to the face of the brake disc segment;

FIG. 5 is a perspective view of another example of a brake disc assembly including an airflow restrictor according to an aspect of the disclosure;

FIG. 6 is a front view of a portion of the brake disc assembly of FIG. 5, with gate members of the airflow restrictor in an open position;

FIGS. 7 and 8 are perspective views of portions of the brake disc assembly of FIG. 5, with the gate members of the airflow restrictor in a closed position;

FIG. 9 is a schematic drawing of another example of a brake disc assembly including an airflow restrictor and adhesive retainer, according to an aspect of the disclosure;

FIG. 10 is a schematic drawing of another example of a brake disc assembly including an airflow restrictor and electromechanical retainer device, according to an aspect of the disclosure;

FIG. 11 is a schematic drawing of another example of a brake disc assembly including an airflow restrictor with a spring formed from a shape memory material, according to an aspect of the disclosure;

FIG. 12 is a schematic drawing of another example of a brake disc assembly including an airflow restrictor and electromechanical biasing member, according to an aspect of the disclosure;

FIG. 13 is a schematic drawing of another example of a brake disc assembly for a wheel mounted brake disc including an airflow restrictor mounted to a radial inner edge of a brake disc segment, according to an aspect of the disclosure;

FIG. 14 is a schematic cross-sectional drawing of a portion of the brake disc assembly of FIG. 13;

FIG. 15A is a schematic drawing of portions of a brake disc assembly for an axial mounted brake disc including an airflow restrictor in an open position;

FIG. 15B is a schematic drawing of portions of the brake disc assembly of FIG. 15A with the airflow restrictor in the closed position;

FIG. 16 is a schematic drawing of another example of a brake disc assembly for a wheel mounted brake disc including an airflow restrictor mounted to a radial outer edge of a brake disc segment, according to an aspect of the disclosure;

FIG. 17 is a schematic cross-sectional drawing of a portion of the brake disc assembly of FIG. 16;

FIG. 18A is another schematic drawing of portions of a brake disc assembly for an axial mounted brake disc with the airflow restrictor in the open position; and

FIG. 18B is a schematic drawing of portions of the brake disc assembly of FIG. 18A with the airflow restrictor in the closed position.

### DETAILED DESCRIPTION

In one embodiment, a brake disc is provided with improved cooling and ventilating structures. The airflow volume and speed across the disc may be optimized and/or maximized to increase a cooling effect. An airflow pattern may be created so that airflow is made available to portions of the disc that may be exposed to substantial heat. Devices and systems for controlling airflow to improve efficiency of the rotating body are may be provided in various embodiments.

Some brake disc assemblies of the disclosure may include structures for directing airflow over or through portions of the brake disc to provide cooling of heat created by the friction between the brake disc and brake shoe. Increasing airflow through and around a brake disc or friction ring may produce drag on the wheel. Wheel drag may reduce efficiency of the wheel and vehicle. Reducing efficiency of the wheel may increase operating costs for the vehicle because additional fuel may be required to account for energy loss due to inefficient rotation of the wheel. Effects of such energy loss become more pronounced for vehicles operating at high speed.

As shown in the figures, this disclosure describes one or more brake disc assemblies 2 including at least one brake disc 10 (referred to as friction rings). The brake disc can be mounted to wheels, hubs, or axles of a rotating body, such as a railway vehicle wheel. As described herein, the brake disc can be a unitary structure (e.g., a monobloc disc) or segmented, as illustrated in the accompanying figures. The brake disc may be contacted by a braking mechanism (not shown). Suitable braking mechanisms may include a brake jaw, brake pad, or brake shoe. During operation, friction produced between the brake disc and brake shoe transforms kinetic energy of the rotating body to heat to decelerate the moving vehicle. Brake discs may be hub mounted or wheel mounted. Hub mounted brake discs (referred to as an axle mounted disc) are connected to the hub 12 or axle (not shown) of the rotating body. Wheel mounted brake discs may be connected directly to a surface of the wheel (not shown) itself rather than to the hub or axle. Brake disc assemblies including features disclosed herein can include hub mounted brake discs or wheel mounted brake discs.

By way of example, a train has nine trailer cars and two locomotives. Such as train would collectively have about 124 brake discs (9 brake discs per trailer car and 8 brake discs per locomotive). As a comparison, such a train running at 300 km/hr and using a conventional brake disc including fins or gills for dissipating heat may absorb 3 kWh of energy. If operating at 300 km/h for 12 hours/day, 300 days/year, it is estimated that the train will lose 1,339,200 kWh of energy per year due to airflow through the brake disc. Reducing energy lost due to rotation of the brake disc by 80% may reduce energy consumption of the train by half.

Brake disc assemblies 2 disclosed herein may include devices or mechanisms, referred to herein as an airflow restrictor 110, 310, 510, 710, 910 or airflow restrictor device, for selectively controlling airflow across or through portions of the brake disc assembly 2. The airflow restrictor can direct, reduce, control, block or restrict airflow in response to activating conditions. Suitable activating conditions may include a temperature of the brake disc that is below a determined temperature value or when a rate of rotation of the brake disc or wheel is above a determined rotational speed value. While the term “restrictor” is used herein, it is meant in the sense that airflow may be selectively directed or controlled such that the airflow restrictor can increase (or decrease) airflow through the friction ring or brake disc segment when the brakes engage (e.g., when the brake shoe contacts the surface of the brake disc creating friction).

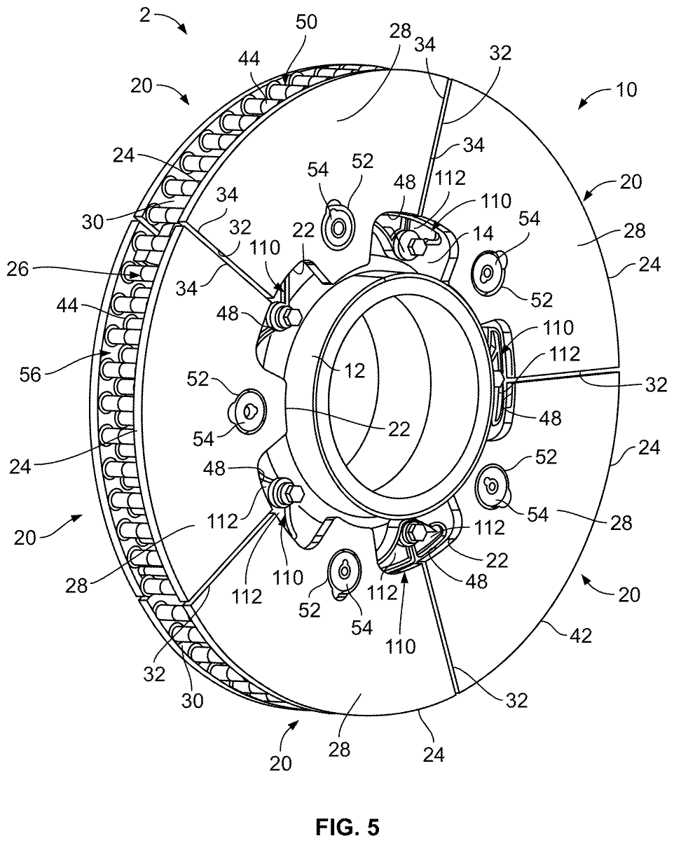

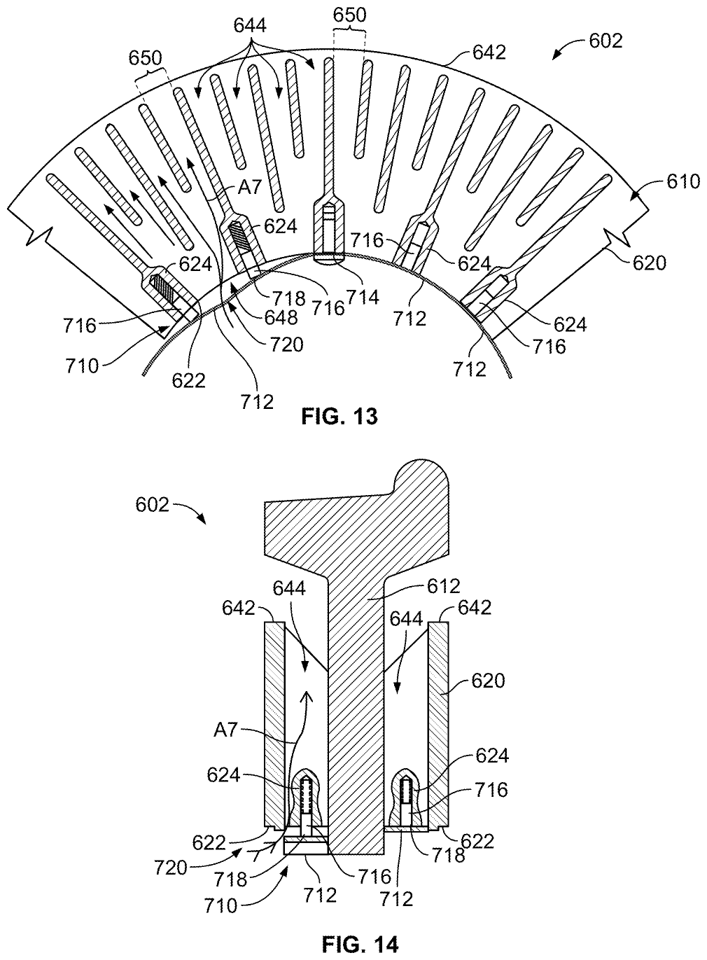

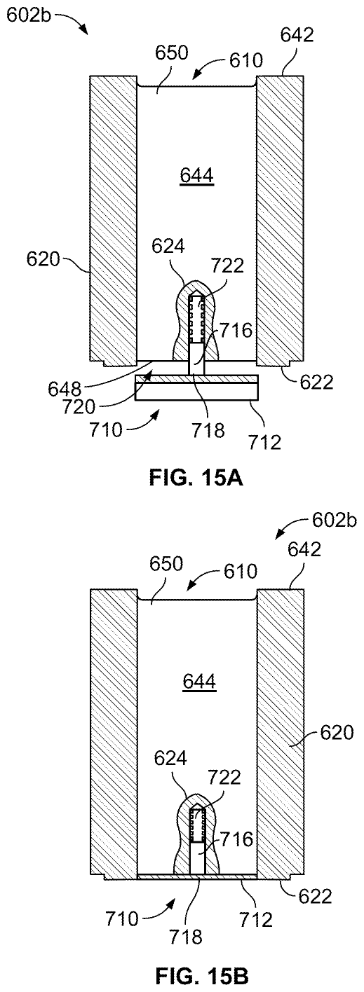

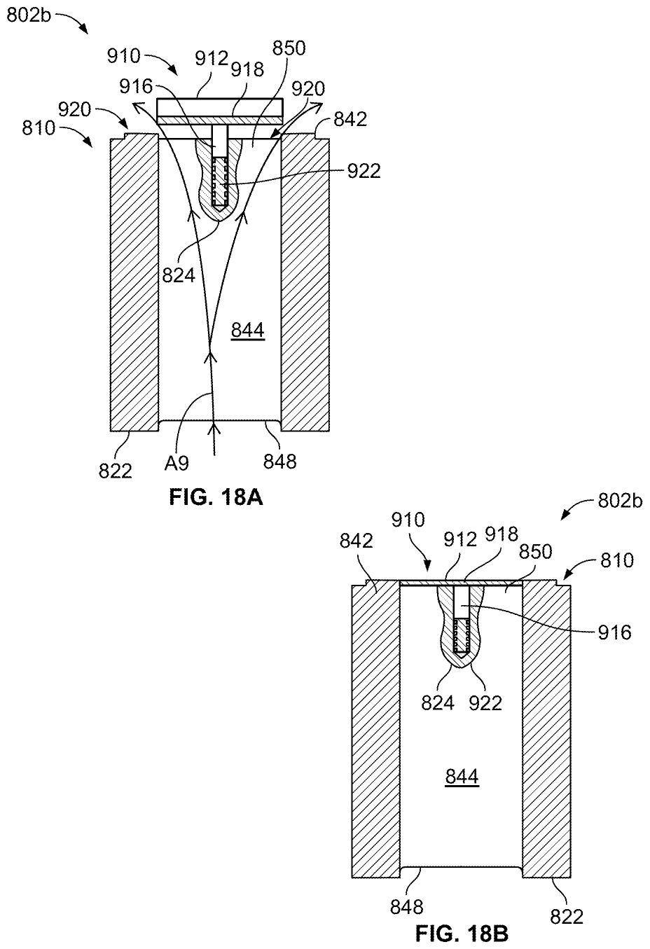

The airflow restrictor can be mounted to any portion of either a wheel mounted brake disc or an axle mounted brake disc within the scope of the present disclosure. For example, airflow restrictors can be mounted to a friction ring, hub, axle, or wheel of a brake disc assembly and/or vehicle. As shown in FIGS. 5-12, airflow restrictors can be mounted to portions of a flange of a hub of an axle-mounted brake disc assembly. Airflow restrictors can be mounted to any portion of a brake disc or brake disc segment. For example, as shown in FIGS. 13, 14, 16, and 17, an airflow restrictor is mounted to either a circumferential inner edge or a circumferential outer edge of a brake disc segment of a wheel mounted brake disc. In still other examples, as shown in FIGS. 15A, 15B, 18A, and 18B, airflow restrictors can be mounted to portions of a brake disc segment of an axle-mounted brake disc assembly. The airflow restrictor disclosed herein may permit optimum or maximum airflow during braking, when friction between the brake shoe and portions of the brake disc creates substantial heat. However, at other times, such as when a vehicle is traveling at a constant high speed and the brakes may be not engaged, airflow may be reduced by the airflow restrictor to improve efficiency of the rotating body. In one embodiment, the airflow is neither maximized nor blocked completely but is allowed at a rate sufficient to cool determined parts without unduly reducing efficiency.

### Exemplary Brake Assemblies

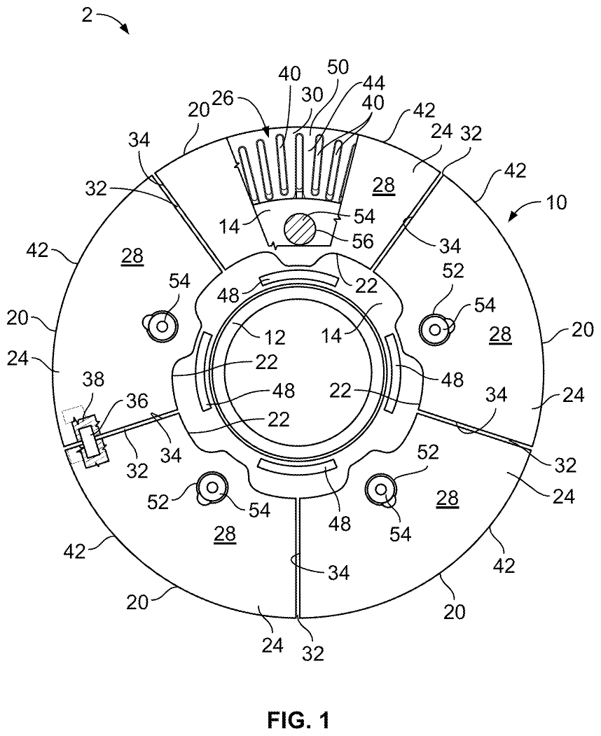

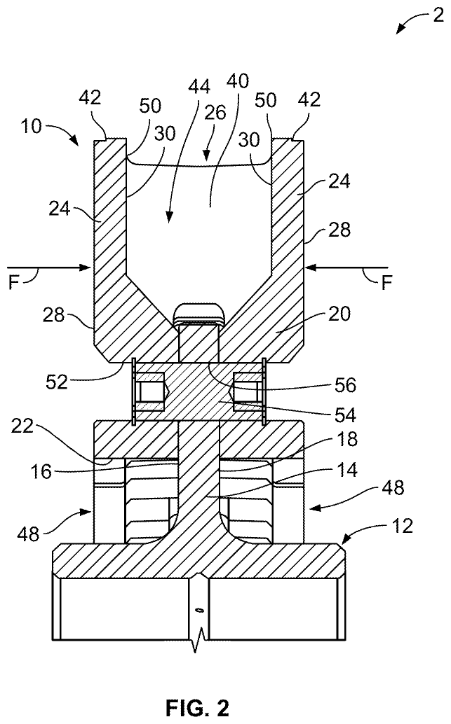

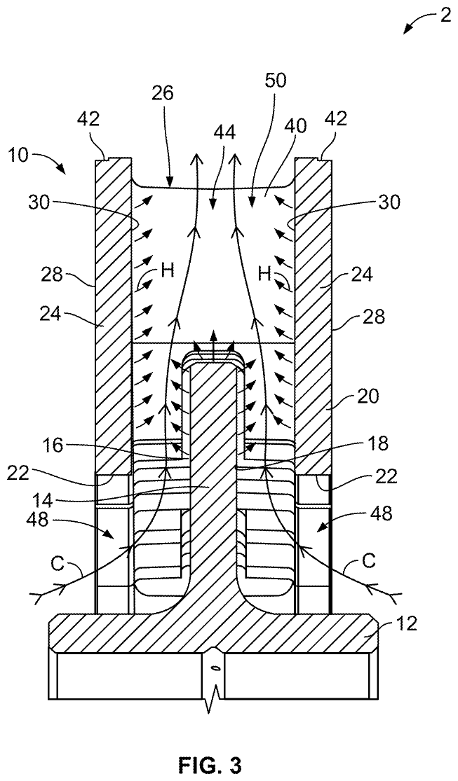

With reference to FIGS. 1 to 4, a hub-mounted brake disc assembly including aspects of the present disclosure is illustrated. The hub mounted brake disc assembly includes the hub 12 having a radial flange 14 extending therefrom. The hub may receive a rotating body, such as an axle of a railway vehicle or similar rotating structure. The flange includes a front side surface 16 and a rear side surface 18 (shown in FIGS. 2 and 3). In one embodiment, the flange may be the same thickness throughout. In another embodiment, the flange may include regions having a different thickness or rigidity. For example, the flange may include alternating concentric bands (not shown) having high and low rigidity. The rigidity of the various regions may result from varying either the thickness or material composition of the flange.

The assembly further includes the friction ring or brake disc attached to the flange. The brake disc can be a segmented disc formed from two or more segments 20. For example, the brake disc can be formed from five substantially identically shaped segments, as shown in the Figures. Each segment can include or be positioned in proximity to one or more of the airflow restrictors (shown in FIGS. 5-8) for limiting airflow through an interior of the segment. For example, as shown in FIG. 5, an airflow restrictor may be positioned adjacent to each circumferential inner edge 22 of the segment.

As shown in FIG. 1, the segment may connect around the hub to form a closed annular ring. While the segment illustrated in FIG. 1 may be the same size and shape, brake disc arrangements may be possible in which different segments have different sizes and/or shapes. Also, the total number of segment may be even or odd.

Each brake disc segment includes two opposing body or plate portions 24 connected together by a plurality of fins, ridges, rods, and/or posts, referred to as inner supports 26. As shown in FIGS. 2 and 3, the plate portions of each segment has an outer surface 28, which functions as a contact or brake surface. The outer surface provides a substantially flat region configured to be contacted by a corresponding brake surface, such as a surface of a brake shoe or brake pad, controlled by a braking mechanism. As described previously, prolonged contact between the outer surface and the brake surface produces friction and heat for decelerating the wheel and/or axle. Optionally, the outer surface may include regions that have been treated or machined to increase texture, hardness, or durability thereof to improve contact and increase the friction between the outer surface and brake surface. The plate portion of the segment includes an inner surface 30 opposite the outer surface. The inner supports extend between inner surfaces of the opposing plate portions.

In one embodiment, the brake segment(s) may be a monolithic structure, in which the opposing plate portions and inner supports may be integrally formed. For example, each segment can be molded or machined as a single monolithic piece. However, in other examples, a segment can include or be formed from two or more symmetrical pieces, such as pieces including a plate portion and half of the inner supports connected to the hub and to each other by, for example, a screw, bolt, or pin.

As shown in FIG. 1, adjacent segments may be separated from one another by a radial gap 32 between radial edges 34 of the adjacent segment. The gap permits free expansion and contraction of the segment due to changes in temperature of the segment, as well as braking and centripetal forces exerted on the segment. In some examples, the segment may be joined together by joining elements, fasteners, or pins 36 extending across the gap and received within corresponding openings or sockets 38 of each segment. A depth of each socket can be greater than the length of the associated joining pin. Accordingly, the segment may be free to move towards or away from each other due to expansion or contraction of the segment, as the joining pin to insert farther into one opening/socket and to pull away from an adjacent segment.

The inner supports can include one or more radial fins 40 extending between the plate portions of the segment. In other examples, the inner supports may include ribs, baffles, columns, walls, posts, or a combination thereof. For example, the inner supports can include a number of posts (not shown) having a substantially circular shaped cross-section extending between the opposing plate portions.

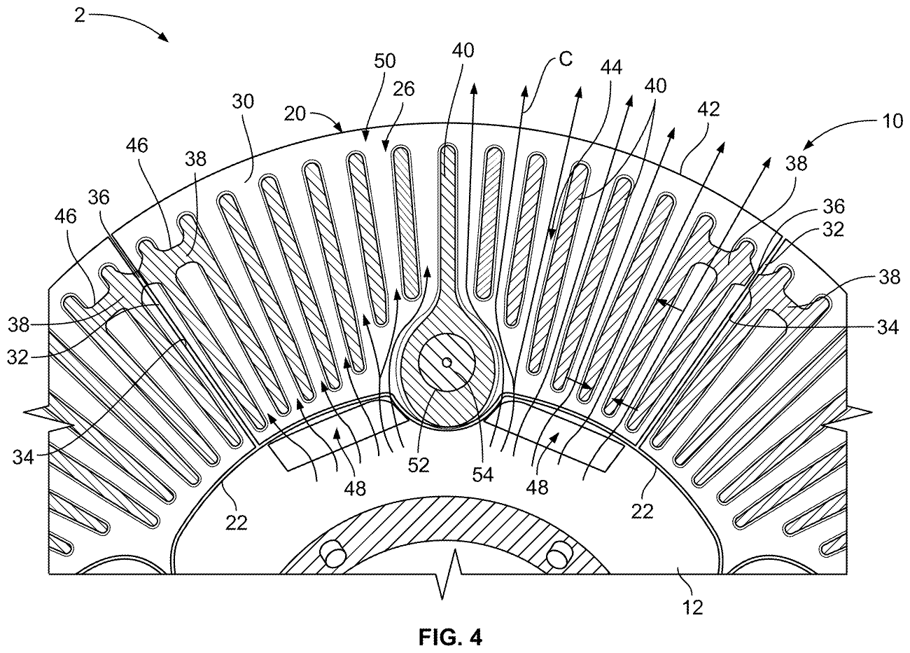

Suitable fins can extend radially between the circumferential inner edge and a circumferential outer edge 42 of each segment, thereby forming or defining channels 44 for directing airflow through the brake disc. The fins can have a variety of designs and arrangements to increase airflow across the inner surfaces 30 of the segment. For example, the fins may have a substantially rectangular or elliptical base area that extends from the inner surface 30 of the plate portion. The fins may be tapered, becoming narrower as a distance from the inner surface(s) 30 increases. The fins may be wider near the inner circumferential side of the segment and narrower near the outer circumferential side, such that the distance between adjacent fins increases farther away from the hub. When the brake disc and wheel rotate, due to centripetal force, external cool air enters the channels 44 through spaces, holes, apertures, or openings between the segment and hub (referred to herein as inflow opening(s) 48) located on the inner circumferential edge of the segment. The cool air passes through the channels as shown by arrow C (in FIGS. 3 and 4), and is expelled from the channels through spaces, holes, slots, apertures, or openings in the circumferential outer edge (referred to herein as outflow opening(s) 50) of the segment. Providing a continual supply of cool air when the brake disc assembly is in use counteracts the effect of heat created from the contact between the segment and brake mechanism. Desirably, cooling and ventilating the segment provides a more even temperature gradient across the segment that prevents degradation of the segment as a result of thermal stresses and thermal expansion.

As shown in FIG. 4, in some examples, a total area for the inflow opening(s) 48 of the brake disc is less than the total area of the outflow opening(s) 50, creating a pneumatic effect, which draws air into the inflow opening(s) 48 and through the channel(s) 44. Also, the increase in total area between the inflow opening(s) 48 and the outflow opening(s) 50 causes the airflow to accelerate along the length of the channel 44, such that an airflow velocity of air near the inflow opening(s) 48 is less than a velocity of the airflow at the outflow opening(s) 50. The increased air velocity can improve ventilation and cooling of the segment.

Each segment further includes at least one through-bore or through-hole 52 configured to receive a fastener 54, such as a bolt, screw, or pin, for fixing the segment to the flange 14 of the hub. Desirably, the number of fixation points (e.g., through-holes 52 and fasteners 54) on each segment is minimized to reduce the number of structures on each segment, which would restrict airflow at times (e.g., when the brakes may be engaged) when maximum airflow is needed to counteract heat produced by friction between the brake segment and brake mechanism. Preferably, each segment includes only a single fixation point, positioned near the circumferential inner edge of the segment. Desirably, the single fastener is sufficiently strong to support loads generated by contact between the brake disc segment and the brake surface. In some examples, the through-holes is deep enough so that a top portion of the fastener is recessed within the through-hole, relative to the outer surface of the plate portion of the segment, so that it does not extend above the outer surface. Recessing the fastener ensures that it does not contact or obstruct the brake surface, such as the brake shoe or brake pad. The flange includes a corresponding through-bore or through-hole 56 aligned with each through-hole of the segment and configured to receive the fastener.

### Exemplary Airflow Restrictors

Aspects of the airflow restrictor will now be described. A suitable airflow restrictor positioned on the brake disc segment, hub, axle (not shown), or wheel (not shown) and configured to limit airflow through the channels 44 formed by the radial fins when cooling airflow is not needed. For example, as described herein, the airflow restrictor(s) can be positioned to block or restrict airflow through one or more of the air inflow openings 48 of the brake segment. In other examples, one or more of the airflow restrictors could be positioned to block airflow from the outflow opening 50. In some examples, the segment can include airflow restrictors blocking airflow into some of the channels 44 and other airflow restrictors positioned at the outflow openings 50 to block air from exiting the channels 44.

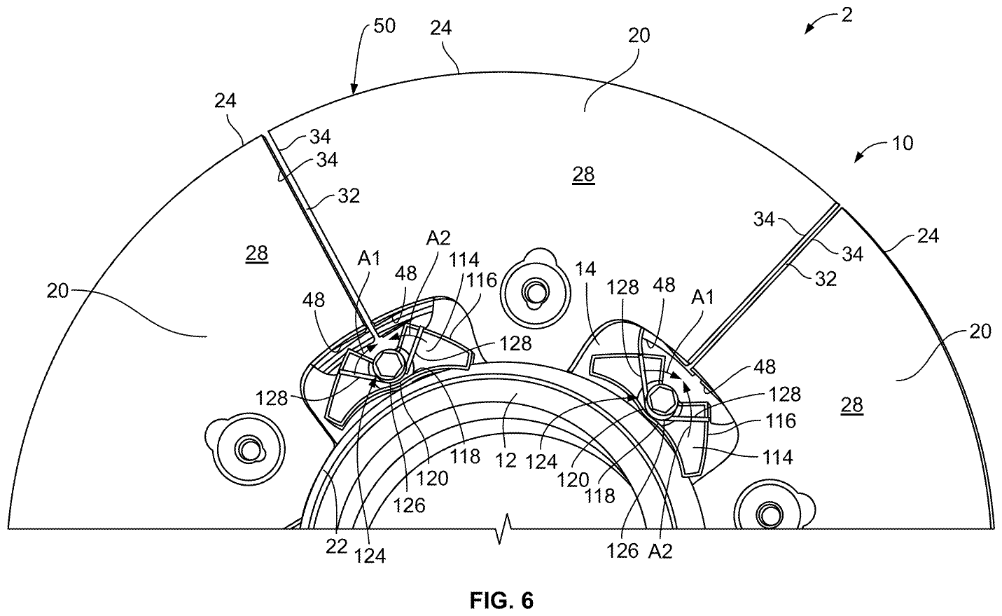

The airflow restrictor(s) include at least one gate member 112. The at least one gate member can be formed from a rigid material suitable for withstanding high temperatures and centripetal forces, such as metal, plastic, and/or composite fibers. As shown in FIGS. 6-8, the at least one gate member includes a main portion 114 having an outer edge 116 sized to align with the inflow opening 48 or the outflow opening 50 of the brake segment. The gate member includes a connector portion 118 including a through-hole 120 or opening sized to receive a fastener 122, such as a bolt or pin. The fastener extends through the through-hole to form a pivot point, such that the gate member freely rotates about the fastener. The at least on gate member can move between a closed position (shown in FIGS. 5, 7, and 8) in which the at least one gate member at least partially covers the air inflow opening to at least partially blocks airflow through the brake disc to an open position (shown in FIG. 6) in which the at least one gate member is spaced apart from the at least one air inflow opening so that air passes into the air inflow opening 48 and through the brake segment.

The at least one gate member can move between the open position and the closed position in response to an activating condition. For example, the activating condition, which causes the at least one gate member to transition from the open position to the closed position, can be when a rate of rotation of the wheel or axle increases above determined activating values. Another activating condition can be a temperature of the brake disc or flange. When a temperature of the brake disc assembly increases above an activating temperature, the at least one gate member can be configured to transition from the closed position to the open position. The activating temperature can be in a range of from about 25 degrees Celsius (° C.) to about 300° C. In one example, the gate member can be configured to remain in the closed position when a temperature of the brake disc and/or at least one gate member is less than about 80° C. and to begin to transition to the open position when the temperature rises above about 80° C. The at least one gate member can be configured to be fully opened when the temperature reaches about 100° C. In other examples, the activating temperature or temperature range can be selected based on the material composition of the brake assembly, the operating conditions of the vehicle, the vehicle type or purpose, the expected ambient environment, and other application specific parameters.

The at least one gate member can be moved between the open position and the closed position by a number of different electrical and/or mechanical actuation mechanisms. For example, as shown in FIGS. 5-7, the airflow restrictor can include at least one biasing member, such as a spring 124. The spring can include a coiled portion 126 wrapped around the fastener and a leg portion 128 connected to the at least one gate member for exerting the biasing force on the gate member to open or close the gate member. The spring can bias the at least one gate member to the open position (as shown in FIGS. 5, 7, and 8). Accordingly, when the vehicle is stationary or moving at low speed, the spring holds the at least one gate member in the open position. As a rate of rotation of the wheel and/or axle increases, centripetal force on the at least one gate member increases, eventually overcoming the biasing force of the spring and causing the gate member to begin to transition to the open position by moving in a direction of arrows A1 and A2 (shown in FIG. 6).

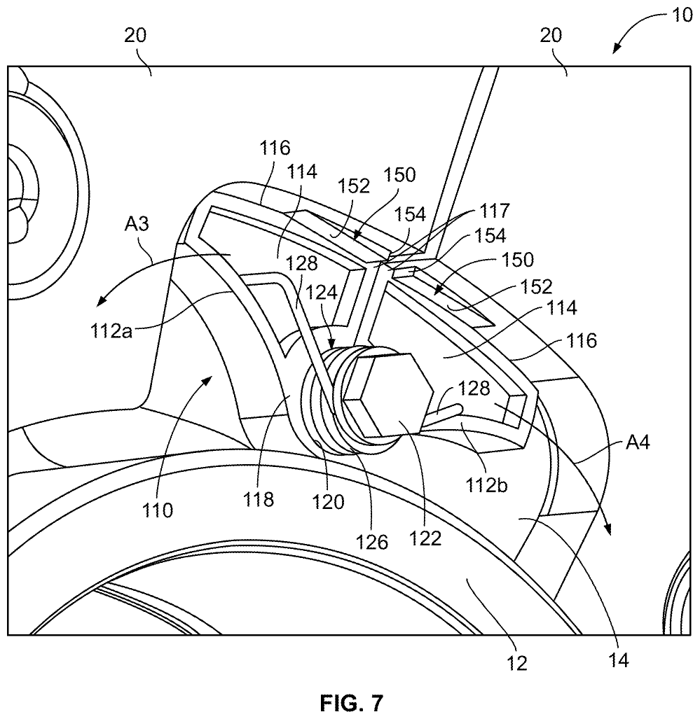

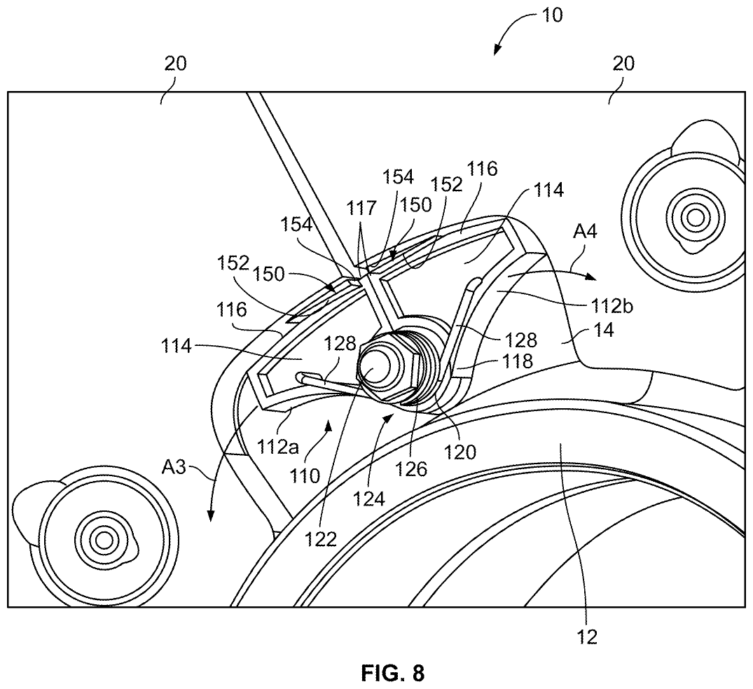

In some examples, the airflow restrictor further includes a retaining tab 150 which, as shown in FIGS. 7 and 8, extends from the circumferential inner edge of the brake segment. The retaining tab can engage a portion of the outer edge, such as a radially extending protrusion 117, of the at least one gate member to maintain the at least one gate member in the closed position. The retaining tab can include a ramped surface 152 positioned to restrict motion of the at least one gate member from the open position to the closed position. The ramped surface increases an amount of centripetal force required to cause the gate member to fully close since, in order to fully close, centripetal force must drive the outer edge and protrusion of the gate member along the ramped surface. The retaining tab includes a vertical or stop surface 154 positioned adjacent to the ramped surface. The stop surface holds the protrusion and outer edge in the closed position. In order to transition the gate member from the closed position to the open position, the protrusion must be driven over the vertical or stop surface by the biasing force of the spring and along the ramped surface towards the open position. Accordingly, the retaining tab serves to maintain the gate member in the closed position for a longer period of time than if a retaining tab were not present. In order to overcome the stop surface, the spring has sufficient force to push the outer edge of the gate member over the stop surface and along the ramped surface back to the open position.

In variant, the retaining tab is formed from a shape memory material or from a bimetallic material, called bimetal retaining tab. When the temperature of the disc in the vicinity of the retaining tab is below the activation temperature, the retaining tab is in a first position in which the tab can hold the gate member thanks for instance to the stop surface as described above. The gate member is thus in its closed position. When the temperature of the disc in the vicinity of the retaining tab exceeds the activation temperature, the retaining tab can move from the first position to a second position in which the tab releases the gate member so that the latter moves from its closed position to its open position. In another variant, the retaining tab can be used as a safety lock in such a way that when the temperature of the disc in the vicinity of the retaining tab exceeds the activation temperature, the tab moves from its second position to its first position (rather than the first position to the second position). The gate member is thus prevented to move again from its open position to its closed position and the disc can cool thanks to the airflow.

In some examples, an airflow restrictor includes two gate members, such as a first gate 112a and a second gate 112b (shown in FIGS. 7 and 8), each of which may be mounted to a single fastener 122 and biased by the same spring. In such examples, the spring can move the first gate member and the second gate member radially away from one another in a direction shown by arrows A3, A4 (in FIGS. 7 and 8) when moving from the closed position to the open position. In order to transition to the closed position, the first gate member and the second gate member move towards one another, due to centripetal force caused by rotation of the axle and wheel, in a direction of arrows A1 and A2 (shown in FIG. 6).

In use, when the vehicle is stationary or operating at low speed, the at least one gate member is in the open position due to the biasing force of the spring. As the vehicle begins to move and the wheel and axle rotate, air is drawn into the inflow opening 48 past the open gate member. In some examples, the radial fins can be arranged to produce a centrifugal pumping effect in which air is drawn into the channels defined by the fins through the inflow openings and expelled through the outflow opening along cooling airflow path C (shown in FIG. 3). Since the vehicle is moving at low speed, effects of drag on the wheel and energy loss caused by the airflow is minimal.

However, as a speed of the vehicle and rate of rotation of the wheel increases, the rotation produces a greater centripetal force, which draws air through the channels 44 at a higher velocity, and which increases drag on the wheel. As the speed of the vehicle increases, the centripetal force exerted on the at least one gate member increases. Eventually, the increased centripetal force overcomes the biasing force of the spring, causing the at least one gate member to move to the closed position. In the closed position, airflow through the channels is partially or fully blocked by the outer edge of the gate member.

To stop or slow rotation of the axle and wheel, a braking force F (shown in FIG. 3) is applied to the outer surface(s) of the segment. The braking force F is transmitted to the flange and hub through the fastener extending through the flange. Since the force F is applied in the circumferential direction, forces exerted on segment contacted by the brake surface (e.g., the brake shoe or pads) may be transmitted to adjacent segment. However, since forces applied to the adjacent segment (e.g., segment on each side of the contacted segment) may be equal in force, but opposite in direction, rotation of the segment is restricted. Therefore, the segment may be effectively locked together, meaning that the brake disc functions as a continuous or unitary structure, even though the segment may be separated by the radial gap. Friction produced by the applied braking force F generates heat H (shown in FIG. 3) which can cause the segment to expand. The heat H is translated from the segment through the inner supports to the flange and hub. The segment may be exposed to the centripetal forces, which tend to push the segment radially outward away from the hub.

Eventually, due to the applied braking force F, the rotation rate of the axle and wheel slows, such that centripetal force on the at least one gate member is reduced to less than the biasing force of the spring. At this point, the biasing force of the spring causes the gate member to move towards the open position. Once the gate member moves away from the air inflow opening, cooling airflow C begins to flow through the channels. The cooling air C flows past the flange of the hub and the inner surface of the segment, thereby causing the heat H to dissipate from the flange and segment. The at least one gate member remains in the open position, under the biasing force of the spring, until the vehicle speed and rate of rotation of the wheel increases enough to generate sufficient centripetal force to overcome the biasing force of the spring, causing the at least one gate member to return to the closed position.

### Gate Member Retention Mechanisms

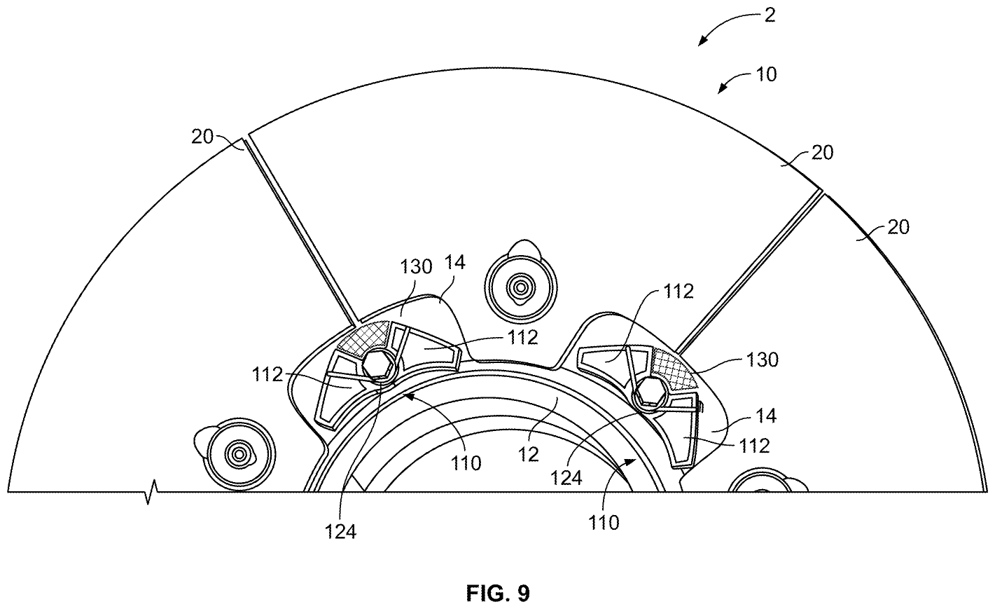

With reference to FIG. 9, in some examples, the airflow restrictor of the brake disc assembly further includes a chemical or mechanical retainer 130 for maintaining the gate member in the closed position. For example, the retainer can be configured to maintain the at least one gate member in a closed position when the vehicle is stationary or moving slowly and to release the at least one gate member when a temperature of a component of the braking assembly rises above an acceptable temperature for brake disc assembly components (e.g., an activating temperature in a range of from about 25° C. to 100° C.).

In other examples, the retainer can be a safety or emergency device which releases the at least one gate member when other components of the airflow restrictor fail to do so and when a temperature of the brake disc assembly rises above a maximum acceptable temperature, such as 300° C. When the retainer releases the gate member, the biasing member, such as the spring, moves the gate member from the closed position to the open position. As in previous examples, centripetal force exerted on the gate member, as the vehicle speed and rate of rotation of the wheel increases, can cause the gate member to return to the closed position and, in some instances, to reconnect to the retainer.

In some examples, the retainer is a chemical retainer. As used herein, a chemical retainer refers to a substance, coating, adhesive, or pad impregnated with a substance that undergoes a change in material properties in response to changes in temperature to release the at least one gate member. For example, the chemical retainer can be a temperature sensitive adhesive on the flange positioned to maintain the least one gate member in the closed position when a temperature of the adhesive is below the activation temperature. When a temperature of the temperature sensitive adhesive increases above the activation temperature, the adhesive dissolves and/or loses adhesive properties, so that the at least one gate member is free to transition to the open position. In some examples, the chemical retainer regains adhesive properties when a temperature of the components of the brake disc assembly returns to a temperature below the activation temperature of the adhesive, so that the adhesive can again engage and hold the at least one gate member in the closed position.

In other examples, the retainer transitions to the non-adhesive state one time and does not regain adhesive properties when the temperature decreases below the activation temperature. For example, the retainer may not need to regain adhesive properties, when the retainer is used as a safety or fail-safe device, which dissolves when a temperature of the brake disc rises substantially above a determined temperature when the gate member should move to the open position. In that case, the retainer may help to maintain the at least one gate member in the closed position when a temperature of the brake disc assembly is within a suitable operating range. Usually, as the wheel decelerates, the biasing force of the spring would overcome the centripetal force caused by rotation of the brake disc and the adhesive force of the retainer, causing the at least one gate member to open. However, if the at least one gate member fails to open for some reason and the temperature of brake disc components continues to increase, the retainer can dissolve or lose adhesive properties, as an added safety measure. When the adhesive force of the retainer is removed, the bias force of the spring can be configured to easily drive the at least one gate member to the open position, thereby providing increased airflow through the brake disc so that the temperature does not continue to increase farther into an unsafe range.

In other examples, the retainer is a mechanical device, which maintains the at least one gate member in the closed position and releases the at least one gate member when an activation condition occurs. For example, the mechanical device could be a lock or latch mechanism that automatically releases in response to increased temperature or pressure. The activation condition can be, for example, when a temperature of the retainer increases above the determined temperature, when a rate of rotation for the axle or wheel decreases below a determined value, or when a pressure or force exerted on the retainer exceeds a determined force value. A mechanical retainer could be, for example, a mechanical lock device including a movable portion (not shown) configured to engage the at least one gate member. When the activation condition occurs, the movable portion automatically moves away from the at least one gate member to release the at least one gate member. For example, the movable portion could be a spring-loaded member which biases away from the at least one gate member when a temperature increases or when a centripetal force exerted on the at least one gate member decreases below a target force or pressure.

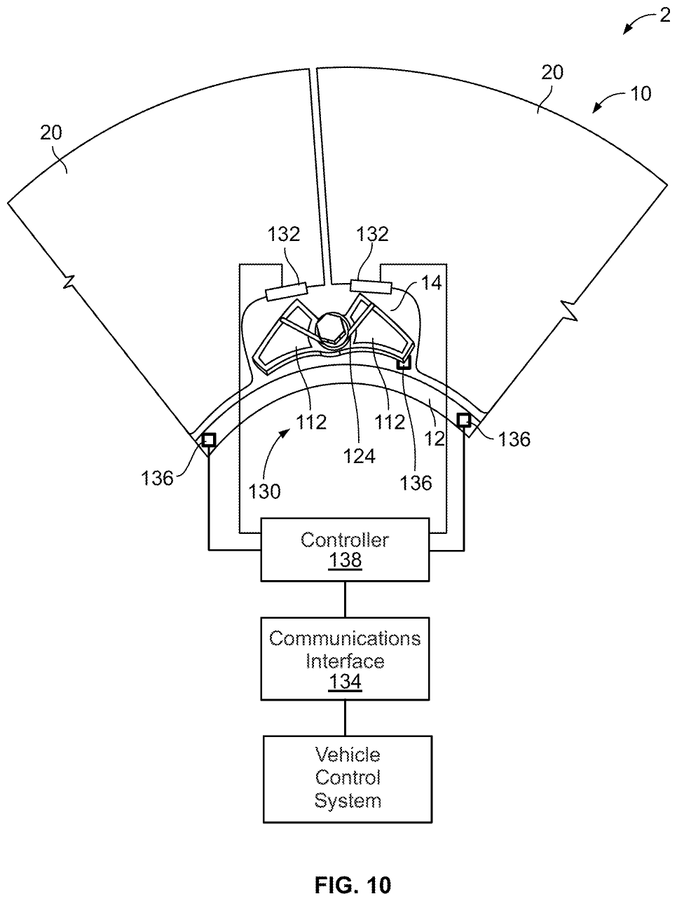

In other examples, with reference to FIG. 10, the retainer is an electromechanical device which releases the gate member in response to a signal received from another electrical device or system. For example, the electromechanical device could receive a signal from the vehicle control system when a speedometer of the vehicle indicates that the speed of the vehicle is less than a determined target speed. Also, the electromechanical device could receive a signal from the vehicle control system to release the at least one gate member, when the brakes may be engaged.

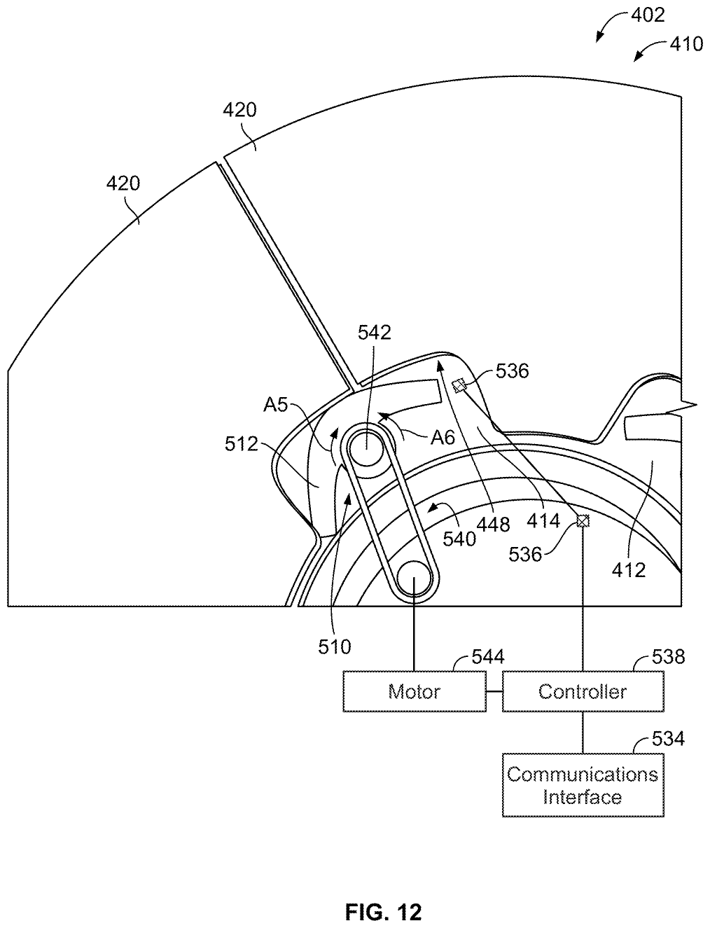

As shown in FIG. 10, the retainer includes electrical circuitry and/or components for operating an electric lock 132, which selectively engages and releases the gate member in response to a signal received from another device or source. The lock can include, for example, a motorized and/or powered actuator which engages or disengages from the at least one gate member. Electrical circuitry for operating the lock can include, for example, a controller 138 electrically connected to a communications interface 134 for receiving instruction from the vehicle control system. The controller can receive and process the instructions from the communications interface and provide instructions to the electric lock to engage or release the at least one gate member. The circuitry can include one or more sensors 136 electrically connected to the controller for detecting information representative of a condition of the brake disc and airflow restrictor. For example, the sensors can detect one or more of a temperature of components of the brake disc assembly, a centripetal force exerted on the gate member due to rotation of the wheel or axle, or a rate of rotation of the brake disc, hub, or axle of the vehicle. When the one or more sensors detect a measurement indicating that the at least one gate member should be released, the controller 138 can cause the electric lock to release the gate member, so that it transitions to the open position due to a force of the spring. In some examples, as described in further detail in connection with FIG. 12, the retainer can include an electrical drive mechanism which moves the at least one gate member from the closed position to the open position.

In use, the at least one gate member is initially in a closed position, blocking airflow through the inflow opening of the brake disc segment. As the vehicle increases in speed, the gate member is maintained in the closed position by the mechanical, electromechanical, or chemical retainer and by the increasing centripetal force exerted on the gate member by the rotation of the wheel and axle. When the brakes may be applied to the rotating wheel and/or brake disc, heat is created from the contact between the brake disc and brake shoe. When the activating condition occurs (e.g., when a temperature of the retainer exceeds a determined temperature value), the retainer releases the at least one gate member. Once released, the biasing force of the spring and/or a force of an electrical drive mechanism forces the at least one gate member towards the open position. The at least one gate member is maintained in the open position by a bias of the spring or electrical device until the brakes release and a speed of the vehicle and rate or rotation of the wheel and axle increases enough to generate substantial centripetal force. The generated centripetal force causes the at least one gate member to move towards the closed position. In some examples, once the at least one gate member reaches the closed position, the retainer, which has reduced in temperature by a sufficient amount to regain its retaining properties, engages the at least one gate member to maintain the at least one gate member in the closed position. The at least one gate member remains in the closed position until the activating condition occurs, causing the retainer to again release the at least one gate member so that it can return to the open position.

Biasing Member Formed from Shape Memory Material or Bimetallic Material

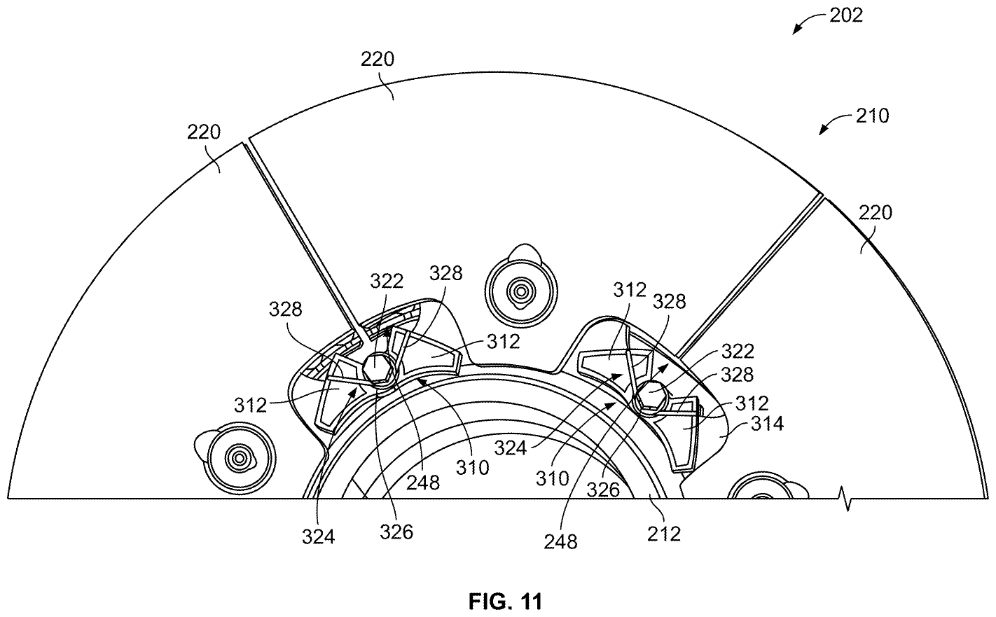

Another example of a brake disc assembly including an airflow restrictor 310 is illustrated in FIG. 11. As in previous examples, the brake disc assembly includes a brake disc 210 formed from a plurality of brake segments 220 connected together to form a ring. The brake disc is mounted to a flange 214 of a hub 212, as in previous examples. as in previous examples, the airflow restrictor 310 includes the at least one gate member 312 pivotally mounted to the fastener 322, such as a bolt or pin. The airflow restrictor 310 includes a biasing member, such as a spring 324. The spring 324 can include the coiled portion 326, wrapped around the fastener 322 and the leg portion 328 extending from the coiled portion 326 to the at least one gate member 312.

Unlike in previous examples, the spring 324 is formed from the shape memory material. A shape memory material can refer to a material that changes shape and/or material properties in response to changes in an activating condition, such as temperature. Some shape memory materials may be referred to as having a one-way memory effect, meaning that such materials change shape in response to the activating condition, but do not return to a previous shape once the activating condition is removed. In contrast, shape memory materials with a two-way memory effect return to an original shape once the activating condition is removed. In order for the gate member 312 to move between the open position and the closed position multiple times during operation of the vehicle, in most examples, the spring 324 is formed from a shape memory material having a two-way memory effect. Exemplary shape memory materials having a two-way memory effect include alloys, such as copper-aluminum-nickel, nickel-titanium (NiTi) alloys, as well as alloys formed from zinc, copper, gold and iron, such as Fe—Mn—Si, Cu—Zn—Al and Cu—Al—Ni. Shape memory polymer materials can be used, as may be known in the art. In variant, the spring is formed from a bimetallic material, called bimetal spring.

In some examples, the spring 324 may change a biasing force direction due to changes in temperature. For example, the spring 324 can be configured to bias the at least one gate member 312 towards the closed position when a temperature of the spring 324 is below an activating temperature and to bias the at least one gate member 312 towards the open position when a temperature of the at least one gate member 312 is above the activating temperature. As in previous examples, the activation temperature is selected to maximize efficiency of the rotating body and vehicle, without damaging components of the braking assembly due to heat caused by braking friction. For example, the activating temperature can be any temperature from about 25° C. to 300° C. or, preferably, from about 80° C. to 100° C. In some examples, the spring 324 can be configured to maintain the at least one gate member 312 in the closed position when a temperature of the spring 324 is below 80° C. When a temperature of the spring 324 increases above 80° C., the spring 324 can begin to move the at least one gate member 312 towards the open position, so that the gate member 312 only partially obstructs an inflow opening 248 of the brake disc 210. The spring 324 can be configured to fully open the at least one gate member 312 when a temperature of the spring 324 is above 100° C.

In use, while the vehicle is stationary or moving at a low speed, the biasing member, such as the shape memory spring 324 or a bimetal spring, maintains the at least one gate member 312 in the closed position, since the temperature of the shape memory material is below the activation temperature. As a speed of the vehicle and/or rate of rotation of the wheel or axle increases, the gate member 312 remains in the closed position. Centripetal force caused by rotation of the brake disc 210 and wheel may contribute to maintaining the at least one gate member 312 in the closed position. When the brakes may be engaged causing the brake shoe to contact the brake disc 210, heat is generated due to the friction between the brake disc 210 and brake shoe. The heat causes a temperature of the shape memory material of the spring 324 to begin to increase. Once the temperature exceeds the activation temperature, the spring 324 begins to bias the gate member 312 towards the open position. Also, the reduced rate or rotation of the wheel or axle, caused by the applied brake forces, reduces the centripetal force on the at least one gate member 312, further contributing to the movement of the gate member towards the open position. In some examples, this movement may occur gradually such that, for a period of time, the gate member partially covers the inflow opening 248, thereby allowing a reduced airflow to pass through channels 244 of the brake disc segment. As the temperature continues to increase and centripetal force decreases, the gate member is pushed farther towards the open position until, eventually, the gate member is separate from the air inflow opening and airflow through the inflow opening and channel is not restricted.

### Airflow Restrictor Including an Electromechanical Actuator

Another example of a brake disc assembly 402 including an airflow restrictor 510 is shown in FIG. 12. The brake disc assembly includes a brake disc 410 formed from a plurality of brake disc segments 420, mounted to a flange 414 of a hub 412. The airflow restrictor(s) 510 may be positioned near air inflow openings 448 of the brake disc segments 420 to selectively block airflow through the segments. As in previous examples, the airflow restrictor includes the at least one gate member 512 for blocking or reducing airflow through the brake segments. As in previous examples, the at least one gate member can move between a closed position, in which the at least one gate member blocks airflow through an inflow opening 448 of the brake disc, and an open position in which the at least one gate member 512 is spaced apart from the inflow opening.

The gate member may be controlled by an electrometrical actuator 540. For example, the electromechanical actuator can include a spindle 542 mechanically coupled to a motor 544. The motor can twist the spindle in a back and forth pattern to transition the gate member between the open and closed positions. As shown in FIG. 12, the gate member is attached to the spindle, such that moving the spindle in a first direction, shown by arrow A5, moves the gate member to the open position. Moving the spindle in a second direction, shown by arrow A6, moves the gate member to the closed position. In other examples, the electromechanical actuator device can be a motorized device, such as a linear actuator, that slides the gate member along a surface of the hub and/or brake disc between the open position and the closed position. For example, a linear actuator could push the gate member radially outwardly along a surface of a flange of the hub to the closed position and could retract the gate member radially inwardly along the surface of the flange to allow airflow through the inflow opening.

As shown in FIG. 12, the electromechanical actuator is mounted to the hub. The motor is electrically connected to a controller 538, which can selectively operate the motor to move the gate member to a desired position. As in previous examples, the airflow restrictor can include a communications interface 534 for receiving instructions to turn on or off the actuator from a remote source, and/or one or more sensors 536 for measuring conditions of the brake disc assembly and/or vehicle (not shown) to determine whether the gate member should be in the open position or the closed position. For example, the at least one sensor can be a temperature sensor, a pressure or force sensor for measuring a centripetal force being exerted on the gate member, a speedometer or velocity sensor for measuring a speed of the vehicle, or a rotation sensor configured to measure a rate of rotation of the brake disc and/or wheel. When a signal is received from the sensor indicating that the gate member should be in a different position (e.g., should move from the closed position to the open position or from the open position to the closed position), the controller provides an activation signal to the electrometrical actuator which exerts a force on the gate member, thereby causing the gate member to move to a new position. Once in the desired position, the actuator may lock the spindle in place by, for example, engaging a mechanical lock. The locked spindle can hold the gate member in the desired position until a signal from the communications interface and/or sensors is received indicating that the gate member should be moved to a new position. When such a signal is received from the communications interface or sensors, the actuator can automatically engage the spindle, to drive the gate member to the new position.

In some examples, the actuator and mechanical lock can maintain the gate member in only two positions (e.g., either an open position or a closed position). In other examples, the actuator may maintain the spindle and gate member connected thereto in any position between the open position and the closed position. Accordingly, the gate member could be held in an intermediate position by the spindle, which permits a reduced airflow to pass through portions of the brake disc in order to dissipate created friction, while reducing drag caused by the brake discs to the greatest extent possible.

### Airflow Restrictors Mounted to Brake Disc Segments

Examples of brake disc assemblies 602, 802 including airflow restrictors are shown in FIGS. 13-18B. Unlike in previous examples, in which the airflow restrictors were mounted to portions of the hub or axle of a vehicle, the airflow restrictors may be mounted to portions of brake disc segments.

For example, a wheel-mounted brake disc assembly including an airflow restrictor 710 mounted to a circumferential inner edge 622 of the segment is shown in FIGS. 13 and 14. As in previous examples, the brake disc assembly includes the brake disc 610 formed from the plurality of the brake disc segments. The segments can be mounted to front or rear surfaces of a wheel 612 (shown in FIG. 14). The airflow restrictor includes a gate member in the form of an arcuate cover 712 having a curvature corresponding to a curvature of the circumferential inner edge of the segment. The arcuate cover may be a thin, lightweight structure which can be positioned to direct airflow into the brake disc segment as the wheel and brake disc rotate. The arcuate cover can be selected from metal, rigid plastic, and/or carbon fiber materials based on application specific parameters. The arcuate cover may be pivotally connected to the brake disc segment at a pivot point 714 (shown in FIG. 13).

In some examples, the arcuate cover can move between a closed position and an open position. In the closed position, the arcuate cover rests against and covers at least a portion of the circumferential inner edge of the segment to at least partially reduce airflow between the circumferential inner edge and a circumferential outer edge 642 of the brake disc segment. For example, the arcuate cover can block airflow through inflow openings 648 of one or more of the channels 644 extending radially along an inner surface of the brake disc segment. In the open position, the arcuate cover is positioned to permit increased airflow through the channels. For example, in the open position, the cover can create or define a gap 720 between the circumferential inner edge of the brake disc segment and the inner surface of the cover. The airflow (shown by arrow A7 in FIG. 13) can pass through the gap and into the channels to pass through the brake disc segments.

In some examples, the airflow restrictor 710 includes a linearly extending pusher 716, such as a piston or flap, positioned in a cavity or receptacle 624 in the brake disc segment. The pusher can include a top positioned to press against an inner surface of the arcuate cover. The top of the pusher can be fixedly or pivotally connected to the arcuate cover. In other examples, the pusher can be separate from, but configured to contact and press against the cover to move the cover radially inwardly and away from the segment. The pusher can extend from and retract into the receptacle. When the pusher extends from the receptacle, it causes the arcuate cover to move to the open position and to create or define the gap for permitting airflow into the channels. When the pusher retracts into the receptacle, the arcuate cover moves to the closed position, in which the cover restricts or blocks airflow into the channels.

In some examples, the pusher is formed from or includes a temperature sensitive spring 722, such as a spring formed from a shape memory material. As in previous examples, the shape memory material can change shape or bias to a new position when a temperature of the spring increases above an activating temperature. For example, the spring can cause the pusher to extend from the receptacle and move the arcuate cover to the open position when a temperature of the spring increases above an activating temperature. The activating temperature can be selected based on material properties of the brake disc assembly and/or operating conditions of the vehicle. For example, the activating temperature can be in a range of from about 25° C. to 49° C. In other embodiments, the activating temperature may be in a range of from about 50° C. to about 100° C. In other embodiments, the activating temperature may be in a range of greater than about 101° C. In a variant, the pusher can be made from a bimetallic material and include a plurality of bimetallic spring washers located successively in the cavity. Each bimetallic spring washer can move from a first position to a second position when the temperature exceeds the activating temperature and the addition of the movement of each of the plurality of bimetallic spring washers permits to move the cover to the open position. When the temperature is below the activating temperature, the bimetallic spring washers move from the second position to the first position, thus pulling the cover to the closed position.

An axle-mounted brake disc assembly 602b including the airflow restrictor is shown in FIGS. 15A and 15B. The airflow restrictor may include the arcuate cover having a curvature corresponding to a curvature of the circumferential inner edge of the segment. The cover can restrict airflow into the brake disc segment through inflow opening(s) 648. However, unlike in the previous example, the brake disc assembly 602b can be mounted to an axle or hub of a vehicle, rather than to a wheel. Otherwise, the airflow restrictor operates in a similar manner to the previous example. For example, the airflow restrictor can include the pusher 716 configured to extend from and retract into the receptacle 624 of the brake disc segment. The pusher can extend in response to the activating condition, such as when a temperature of the pusher and/or temperature sensitive spring 722 increases above the activating temperature. As in previous examples, extending the pusher causes the arcuate cover to move to the open position. Retraction of the pusher causes the arcuate cover to return to the closed position.

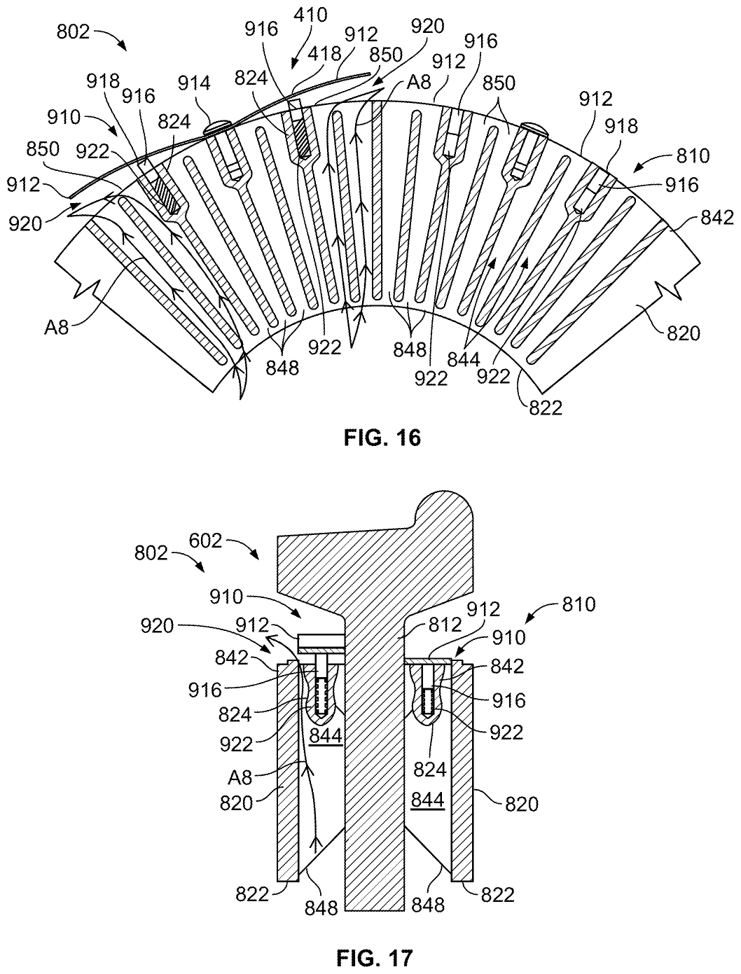

Another example of an airflow restrictor for a wheel-mounted brake disc assembly is shown in FIGS. 16 and 17. The airflow restrictor can cover the circumferential outer edge 842 of a brake disc segment 820 rather than a circumferential inner edge 822 thereof. The brake disc assembly includes the brake disc 810 formed from a plurality of brake disc segments. The airflow restrictor includes a gate member in the form of an arcuate cover 912 having a curvature corresponding to a curvature of the circumferential outer edge 842 of the segment. The arcuate cover 812 can be pivotally connected to the brake disc segment at a pivot point 914 (shown in FIG. 16). The arcuate cover can move between a closed position and an open position. In the closed position, the arcuate cover rests against and covers at least a portion of the circumferential outer edge 842 of the segment to at least partially reduce airflow through a channel 844 extending between the circumferential inner edge 822 and the circumferential outer edge of the brake disc segment. The arcuate cover can be configured to block airflow through one or more outflow openings 850 of the channels. In the open position, the arcuate cover pivots away from the brake disc segment(s) creating a gap 920, to permit airflow from the channel to pass away from the brake disc segment in a direction of arrow A8 (shown in FIG. 16).

As in previous examples, the airflow restrictor can include a linearly extending pusher 916 positioned in a cavity or receptacle 824 adjacent to the circumferential outer edge 842 of the brake disc segment. The pusher is configured to extend from and retract into the receptacle. When the pusher extends from the receptacle, it causes the arcuate cover to move to the open position. When the pusher retracts into the receptacle, the arcuate cover moves to the closed position. As in previous examples, the pusher can be formed from or includes a temperature sensitive spring 922, such as a spring formed from a shape memory material. The spring can cause the pusher to extend when a temperature of the spring increases above an activating temperature. Extension of the spring causes the arcuate cover to move to the open position. In variant, the pusher is made from a bimetallic material and comprises for instance a plurality of bimetallic spring washers located successively in the cavity. Each bimetallic spring washer is configured to move from a first position to a second position when the temperature exceeds the activating temperature and the addition of the movement of each of the plurality of bimetallic spring washers permits to move the cover to the open position. When the temperature is below the activating temperature, the bimetallic spring washers move from the second position to the first position, thus pulling the cover to the closed position.

An axle mounted brake disc assembly 802b including the airflow restrictor is shown in FIGS. 18A and 18B. As in the previous example, the airflow restrictor is mounted to the circumferential outer edge of the brake disc segment. The airflow restrictor includes the arcuate cover pivotally connected to the brake disc segment at the pivot point (shown in FIG. 16). The arcuate cover is moved by the pusher extending from the receptacle. As in previous examples, the pusher may extend from the receptacle to move the arcuate cover to the open position and to retract into receptacle to move the arcuate cover to the closed position. In the open position, airflow (shown by arrow A9 in FIG. 18A) passes through the channel defined between opposing sides of the brake disc segment and away from the brake disc segment through the gap defined between the inner surface of the arcuate cover and the circumferential outer edge of the segment.

Some gate members can be located at the inlet of the channels and/or at the outlet of the channels and/or inside the channels in order to restrict or not the airflow which passes trough said channels. In particular, the channels may be defined in the disc and the gate members can be fastened on the wheel, on the hub or on the disc itself so that the gate members may be substantially radially oriented with respect to the channels. Said otherwise, the gate members may be not located substantially parallel to the channels.

The gate members can be moved from the closed position to the open position and inversely in response to a translation movement or to a rotation movement with respect to the inlet and/or to the outlet of the channels. The gate members can be moved radially or axially, taking into account that the axis is defined in the channels between the inlet and the outlet thereof.

The biasing members can operate a translation movement and/or a rotation movement and/or a flexion movement to act on the gate members and move them in translation and/or in rotation. In one embodiment, the biasing member and the gate member can be a single monolithic piece.

In one embodiment, a brake disc assembly for a vehicle is provided. The brake disc assembly is configured to control airflow through portions of the brake disc assembly, and includes a brake disc, at least one airflow restrictor, and an actuator. The at least one airflow restrictor includes at least one gate member configured to move between a closed position and an open position. In the closed position, the at least one gate member at least partially reduces airflow between a circumferential inner edge and a circumferential outer edge of the brake disc. In the open position, the at least one gate member is positioned to permit increased airflow between the circumferential inner edge and the circumferential outer edge of the brake disc, relative to when the at least one gate member is in the closed position. The actuator is coupled to the at least one airflow restrictor and configured to move the restrictor between the open position and the closed position.

Optionally, the brake disc is a multi-segment brake disc including a plurality of connected brake disc segments, with each segment including a circumferential inner edge, a circumferential outer edge, and at least one channel extending between the circumferential inner edge and the circumferential outer edge. For example, each brake disc segment may include a pair of opposing plate portions comprising an inner surface and an outer surface configured to be contacted by a brake mechanism, and an inner support portion comprising a plurality of radially extending fins extending between the inner surfaces of the plate portions. The fins define the at least one channel extending between the circumferential inner edge and the circumferential outer edge of the brake disc segment.

Optionally, the actuator is configured to move the at least one gate member between the open position and the closed position when exposed to an activating condition. For example, activating condition may include one or more of centripetal force on the at least one gate member, a velocity of the vehicle, and a rate of rotation of the brake disc, hub, axle, or wheel.

Optionally, the actuator further comprises at least one biasing member mounted between at least one of the brake disc, hub, axle, or wheel and the at least one gate member. The biasing member biases the at least one gate member to the open position. For example, the at least one gate member may exert a centripetal force against the biasing member, which increases as a velocity of the vehicle and/or rate of rotation of the axle, hub, or wheel increases, such that a holding force exerted by the at least one gate member on the at least one biasing member overcomes a biasing force of the at least one biasing member, once the vehicle reaches a determined speed, thereby causing the at least one gate member to transition from the open position to the closed position.

Optionally, the at least one airflow restrictor includes a first gate member and a second gate member. While transitioning from the open position to the closed position, the first gate member and the second gate member rotate towards one another about a fixed point, and, while transitioning from the closed position to the open position, the first gate member and the second gate member rotate away from one another about the fixed point.

Optionally, the actuator includes an electronically controlled actuator which causes the at least one gate member to transition between the open position and the closed position.

Optionally, the actuator includes a biasing member formed from a shape memory material. When a temperature of the biasing member is below a determined activating temperature, the biasing member biases the at least one gate member to the closed position, and, when the temperature of the biasing member exceeds the determined activating temperature, the biasing member biases the at least one gate member to the open position.

Optionally, the actuator includes a biasing member and at least one chemical or mechanical retainer. The biasing member is configured to bias the at least one gate member to the open position. The at least one chemical or mechanical retainer is configured to maintain the at least one gate member in the closed position over the biasing force of the at least one biasing member until an activating condition occurs, and, upon occurrence of the activating condition, the retainer releases the at least one gate member such that, under a bias of the biasing member, the at least one gate member moves to the open position. For example, the at least one chemical retainer comprises a reusable temperature sensitive chemical adhesive which releases when a temperature of the adhesive exceeds a determined activating temperature.

Optionally, the brake disc includes at least one tab extending from a circumferentially inward edge of the brake disc and configured to engage the at least one gate member to maintain the at least one gate member in the closed position. The at least one tab includes a ramped surface and a vertical surface. The ramped surface counteracts movement of the at least one gate member from the open position to the closed position, and the vertical surface maintians the at least one gate member in the closed position.

Optionally, the actuator includes at least one linearly extending pusher connected to the at least one gate member. The pusher is configured to extend to move the at least one gate member to the open position, and to retract to permit the at least one gate member to move to the closed position. For example, the at least one pusher may be mounted to the brake disc and, when extended, may be configured to push at least a portion of the at least one gate member away from the brake disc. As another example, the at least one gate member may include an arcuate cover pivotally mounted to the circumferential inner edge or the circumferential outer edge of the brake disc and configured to be moved by the at least one pusher.

In one embodiment, a brake disc hub of a vehicle includes an annular body, at least one airflow restrictor, and an actuator. The annular body includes a radially inner portion configured to receive an axle of a vehicle and a radially extending flange configured to be connected to a brake disc. The at least one airflow restrictor includes at least one gate member mounted to the flange of the hub configured to move between a closed position and an open position. In the closed position, the at least one gate member at least partially reduces airflow between a circumferential inner edge and a circumferential outer edge of the brake disc. In the open position, the at least one gate member is positioned to permit increased airflow between the circumferential inner edge and the circumferential outer edge of the brake disc, relative to when the at least one gate member is in the closed position. The actuator is coupled to the at least one airflow restrictor and configured to move the restrictor between the open position and the closed position.

In one embodiment, a method includes positioning at least one gate member of an airflow restrictor in a closed position, wherein the at least one gate member at least partially reduces airflow between a circumferential inner edge and a circumferential outer edge of a brake disc in the closed position. The method also includes moving, via an actuator, the at least one gate member to an open position, in which the at least one gate member is positioned to permit increased airflow between the circumferential inner edge and the circumferential outer edge of the brake disc, relative to when the at least one gate member is in the closed position.

Optionally, the actuator moves the at least one gate member between the open position and the closed position responsive to an activating condition. The activating condition includes one or more of centripetal force on the at least one gate member, a velocity of the vehicle, and a rate of rotation of the brake disc, hub, axle, or wheel.

Optionally, the at least one airflow restrictor includes a first gate member and a second gate member. While transitioning from the open position to the closed position, the first gate member and the second gate member rotate towards one another about a fixed point, and, while transitioning from the closed position to the open position, the first gate member and the second gate member rotate away from one another about the fixed point.

While specific embodiments of the brake disc and airflow restrictor have be described in detail, the arrangements disclosed are illustrative and not limiting as to the scope of the disclosure which is to be given the full breadth of the claims appended and any and all equivalents thereof. One or more features of any embodiment can be combined with one or more features of any other embodiment.

The description enables one of ordinary skill in the relevant art to make and use the described embodiments contemplated for carrying out aspects of the disclosure. Various modifications, equivalents, variations, and alternatives, however, will remain readily apparent. Any and all such modifications, variations, equivalents, and alternatives may be intended to fall within the scope of the disclosure. The devices illustrated in the attached drawings, and described in the following specification, may be simply exemplary embodiments of the disclosure. For purposes of the description hereinafter, the terms “end”, “upper”, “lower”, “right”, “left”, “vertical”, “horizontal”, “top”, “bottom”, “lateral”, “longitudinal”, and derivatives thereof shall relate to the disclosure as it is oriented in the drawing figures.

1. A brake disc assembly for a vehicle configured to control airflow through portions of the brake disc assembly, comprising:
a brake disc;
at least one airflow restrictor comprising at least one gate member configured to move between a closed position, in which the at least one gate member at least partially reduces airflow between a circumferential inner edge and a circumferential outer edge of the brake disc, and an open position, in which the at least one gate member is positioned to permit increased airflow between the circumferential inner edge and the circumferential outer edge of the brake disc, relative to when the at least one gate member is in the closed position; and
an actuator coupled to the at least one airflow restrictor and configured to move the restrictor between the open position and the closed position.

2. The brake disc assembly of claim 1, wherein the brake disc is a multi-segment brake disc comprising a plurality of connected brake disc segments, each segment comprising a circumferential inner edge, a circumferential outer edge, and at least one channel extending between the circumferential inner edge and the circumferential outer edge.

3. The brake disc assembly of claim 2, wherein each brake disc segment comprises:
a pair of opposing plate portions comprising an inner surface and an outer surface configured to be contacted by a brake mechanism; and
an inner support portion comprising a plurality of radially extending fins extending between the inner surfaces of the plate portions, and
the fins define the at least one channel extending between the circumferential inner edge and the circumferential outer edge of the brake disc segment.

4. The brake disc assembly of claim 1, wherein the actuator is configured to move the at least one gate member between the open position and the closed position when exposed to an activating condition.

5. The brake disc assembly of claim 4, wherein the activating condition comprises one or more of centripetal force on the at least one gate member, a velocity of the vehicle, and a rate of rotation of the brake disc, hub, axle, or wheel.

6. The brake disc assembly of claim 1, wherein the actuator further comprises at least one biasing member mounted between at least one of the brake disc, hub, axle, or wheel and the at least one gate member, wherein the biasing member biases the at least one gate member to the open position.

7. The brake disc assembly of claim 6, wherein the at least one gate member exerts a centripetal force against the biasing member, which increases as a velocity of the vehicle and/or rate of rotation of the axle, hub, or wheel increases, such that a holding force exerted by the at least one gate member on the at least one biasing member overcomes a biasing force of the at least one biasing member, once the vehicle reaches a determined speed, thereby causing the at least one gate member to transition from the open position to the closed position.

8. The brake disc assembly of claim 1, wherein the at least one airflow restrictor comprises a first gate member and a second gate member, and wherein while transitioning from the open position to the closed position, the first gate member and the second gate member rotate towards one another about a fixed point, and while transitioning from the closed position to the open position, the first gate member and the second gate member rotate away from one another about the fixed point.

9. The brake disc assembly of claim 1, wherein the actuator comprises an electronically controlled actuator which causes the at least one gate member to transition between the open position and the closed position.

10. The brake disc assembly of claim 1, wherein the actuator comprises a biasing member formed from a shape memory material, wherein when a temperature of the biasing member is below a determined activating temperature, the biasing member biases the at least one gate member to the closed position, and wherein when the temperature of the biasing member exceeds the determined activating temperature, the biasing member biases the at least one gate member to the open position.

11. The brake disc assembly of claim 1, wherein the actuator comprises a biasing member configured to bias the at least one gate member to the open position; and at least one chemical or mechanical retainer configured to maintain the at least one gate member in the closed position over the biasing force of the at least one biasing member until an activating condition occurs, and, upon occurrence of the activating condition, the retainer releases the at least one gate member such that, under a bias of the biasing member, the at least one gate member moves to the open position.

12. The brake disc assembly of claim 11, wherein the at least one chemical retainer comprises a reusable temperature sensitive chemical adhesive which releases when a temperature of the adhesive exceeds a determined activating temperature.

13. The brake disc assembly of claim 1, wherein the brake disc comprises at least one tab extending from a circumferentially inward edge of the brake disc, the at least one tab being configured to engage the at least one gate member to maintain the at least one gate member in the closed position, and
the at least one tab comprises a ramped surface, which counteracts movement of the at least one gate member from the open position to the closed position, and a vertical surface for maintaining the at least one gate member in the closed position.

14. The brake disc assembly of claim 1, wherein the actuator comprises at least one linearly extending pusher connected to the at least one gate member, the pusher being configured to extend to move the at least one gate member to the open position and to retract to permit the at least one gate member to move to the closed position.

15. The brake disc assembly of claim 14, wherein the at least one pusher is mounted to the brake disc and, when extended, is configured to push at least a portion of the at least one gate member away from the brake disc.

16. The brake disc assembly of claim 14, wherein the at least one gate member comprises an arcuate cover pivotally mounted to the circumferential inner edge or the circumferential outer edge of the brake disc and configured to be moved by the at least one pusher.

17. A brake disc hub of a vehicle, comprising:
an annular body comprising a radially inner portion configured to receive an axle of a vehicle and a radially extending flange configured to be connected to a brake disc;
at least one airflow restrictor comprising at least one gate member mounted to the flange of the hub configured to move between a closed position, in which the at least one gate member at least partially reduces airflow between a circumferential inner edge and a circumferential outer edge of the brake disc, and an open position, in which the at least one gate member is positioned to permit increased airflow between the circumferential inner edge and the circumferential outer edge of the brake disc, relative to when the at least one gate member is in the closed position; and
an actuator coupled to the at least one airflow restrictor and configured to move the restrictor between the open position and the closed position.

18. A method, comprising:
positioning at least one gate member of an airflow restrictor in a closed position, wherein the at least one gate member at least partially reduces airflow between a circumferential inner edge and a circumferential outer edge of a brake disc in the closed position; and
moving, via an actuator, the at least one gate member to an open position, in which the at least one gate member is positioned to permit increased airflow between the circumferential inner edge and the circumferential outer edge of the brake disc, relative to when the at least one gate member is in the closed position.

19. The method of claim 18, wherein the actuator moves the at least one gate member between the open position and the closed position responsive to an activating condition, wherein the activating condition comprises one or more of centripetal force on the at least one gate member, a velocity of the vehicle, and a rate of rotation of the brake disc, hub, axle, or wheel.

20. The method of claim 18, wherein the at least one airflow restrictor comprises a first gate member and a second gate member, and wherein while transitioning from the open position to the closed position, the first gate member and the second gate member rotate towards one another about a fixed point, and while transitioning from the closed position to the open position, the first gate member and the second gate member rotate away from one another about the fixed point.
